(19) United States
(12) Patent Application Publication
(10) Pub. No.: US 2022/0347790 A1
(43) Pub. Date: Nov. 3, 2022

(54) METHOD FOR INSPECTING AND POST-PROCESSING A WORKPIECE HAVING A LASER-CUT, CLOSED INNER CONTOUR

(71) Applicant: JENOPTIK Automatisierungstechnik GmbH, Jena (DE)

(72) Inventors: Torsten REICHL, Jena (DE); Robert MICHEL-TRILLER, Jena (DE)

(21) Appl. No.: 17/620,355

(22) PCT Filed: Jun. 17, 2020
(86) PCT No.: PCT/DE2020/100508

§ 371 Date: Dec. 17, 2021

(30) Foreign Application Priority Data
Jun. 20, 2019 (DE) 10 2019 116 735.3

(51) Int. Cl. B23K 26/03; G01N 21/954; G06T 7/00; G06T 7/64; G06T 1/00

(52) U.S. Cl. CPC B23K 26/03; G01N 21/954; G06T 7/0006; G06T 7/64; G06T 1/0014; B23K 26/38

(57) ABSTRACT

A method for inspecting and post-processing a workpiece having a laser-cut, closed inner contour, in which method a gripper moves a workpiece picked up in a defined manner, between a previously stored pre-defined pick-up position AP and a pre-defined first gripper position GP1, delivering the workpiece to an inspection unit, and if post-processing is required, a pre-defined second gripper position GP2, delivering the workpiece to an ejector unit.

### PRIORITY CLAIM

The present application is a National Phase entry of PCT Application No. PCT/DE2020/100508, filed Jun. 17, 2020, which claims priority from German Patent Application No. 10 2019 116 735.3, filed Jun. 20, 2019, the disclosures of which are hereby incorporated by reference herein in their entirety.

### FIELD OF THE INVENTION

A large number of off-line or post-process methods are known from the prior art, in which the processing quality of a laser cutting process is assessed after completion of the laser cutting process. This means that various characteristics of the cut quality or of the cut product are assessed.

### DESCRIPTION OF PRIOR ART

EP 3 159 093 B1 discloses a method for inspecting the results of laser cutting operations, wherein quality control is carried out automatically after interruption and/or completion of a laser cutting operation performed according to predetermined cutting parameters. In this method, at least one section of the cut contour is scanned and, based on the scan results, at least one quality characteristic of the processing result is automatically determined and compared with predefined quality characteristics. Depending on the result of the comparison, at least either an error message is output, the cutting operation is aborted, at least one cutting parameter is adjusted, the cut contour is at least partially reworked, or the laser cutting operation is continued if it was interrupted for inspection. The quality characteristics specifically determined here include a slag residue in a kerf along the cut contour, a kerf width, and a cut edge roughness.

In many cases where cut contours are produced on workpieces by means of lasers, the immediate characteristics of the resulting cut contour, such as a low cut edge roughness, an exact contour profile or a cut contour that runs completely through the workpiece, are not the actual goal. Frequently, the cut contour (closed inner contour) circumscribes a part of the workpiece (slug) that is to be cut out of the workpiece. This means that, in the end, all that matters is that a slug which is enclosed by the cut contour and may be a usable part or waste has actually been removed from the workpiece.

For example, DE 10 2011 004 117 A1 discloses a method wherein, after cutting a small inner contour, the cutting head used to cut the inner contour is positioned in the center of the contour and, when the laser beam penetrates again, it is possible to conclude from any emissions produced, as they occur during laser cutting in interaction with the material of the workpiece, that the slug enclosed by the inner contour has not fallen out.

A similar method is described in DE 10 2010 039 525 A1 according to which the presence of the slug enclosed by a cut inner contour is checked with the distance sensor of the cutting nozzle. The latter two methods have the disadvantage that the inspection of the workpiece is carried out with the workpiece clamped and assigned to the cutting head, or cutting nozzle, as it was during the laser cutting process. This means that the device in which the laser cutting process was performed remains blocked from performing further laser cutting processes, at least for the period of time during which inspection takes place.

### SUMMARY OF THE INVENTION

It is the object of the invention to find a method for the automatic inspection and post-processing of workpieces on which a closed inner contour has been cut by laser, which method can be carried out after the laser cutting process as well as independently of said process and of the handling devices used therein.

This object is achieved by a method according to claim 1.

Advantageous embodiments thereof are indicated in subclaims 2 to 7 which refer back to claim 1.

The basically finished workpiece is picked up by a gripper of a handling robot or transferred to it. The gripper is in a predetermined pick-up position AP and the workpiece assumes a predefined relative position with respect to the gripper.

The subsequent description of a process according to the invention will be given for the sake of simplicity for the control (inspection) and possible post-processing of a workpiece with only one internal contour. For inspection and possible post-processing of further inner contours, the individual process steps are repeated analogously, with different first and second gripper positions being stored for different inner contours and being assumed by the gripper. If the workpiece cannot be held by the gripper in the same relative position to the gripper for the inspection of further internal contours, the gripper is moved back to the pick-up position and the workpiece is deposited in a defined manner. The workpiece is then gripped again from another predetermined pick-up position, which the gripper assumes, in order to inspect the internal contour that could not previously be inspected optically.

The coordinates of the control points to be inspected are recorded in relation to the gripper before the process and stored as nominal coordinates. The recording can be done on the basis of a sample workpiece or derived from the design documents.

It is essential to the invention that the gripper is automatically moved in a controlled manner between a predetermined pick-up position, in which it picks up the workpiece in a defined and reproducible manner, a predetermined first gripper position, in which it feeds the workpiece to an inspection unit in a defined and reproducible manner, and optionally a predetermined second gripper position, in which it feeds the workpiece to an ejection unit in a defined and reproducible manner. The pick-up position and the two gripper positions were previously taught to a control unit connected to the handling robot.

The process takes place after completion of the actual laser cutting process and and detached from the latter, so that the actual laser cutting is not prolonged by the inspection and possible post-processing using the handling equipment used during the laser cutting process. This means that the production line on which the laser cutting process is carried out is not unnecessarily blocked and the inspection and, optionally, post-processing of a workpiece can be carried out in parallel with the processing of another workpiece.

### BRIEF DESCRIPTION OF THE DRAWINGS

The invention will be explained in more detail below with reference to an exemplary embodiment and drawings.

In the drawings:

FIG. 1a is a schematic diagram showing a handling robot with a gripper located in a pick-up position, a first gripper position or a second gripper position alternatively, and

FIG. 1b is a top view showing part of a workpiece.

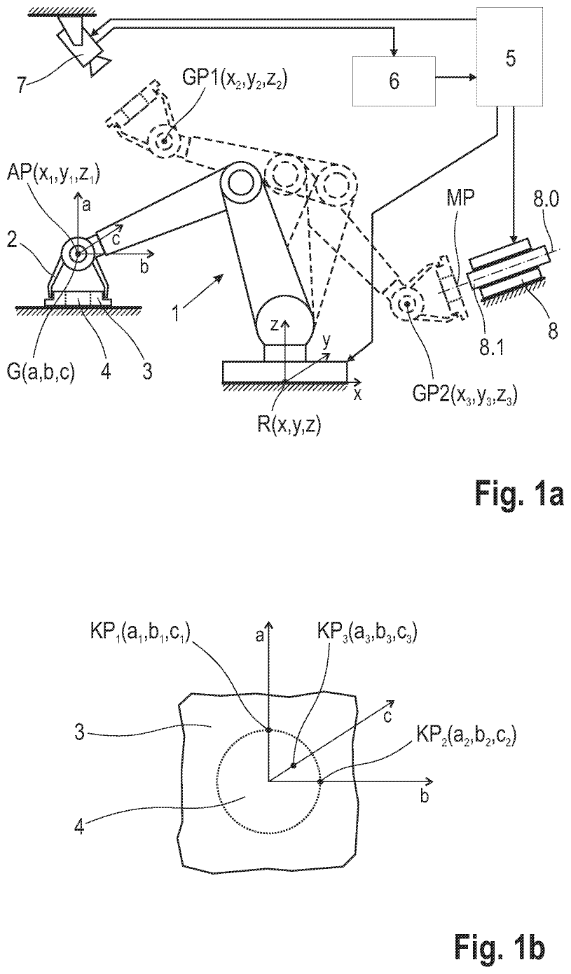

### DETAILED DESCRIPTION OF THE DRAWINGS

The method according to the invention is used to optically check (inspect) a workpiece 3 with a laser-cut closed inner contour 4 to determine whether a slug formed by the laser cutting of the inner contour 4 and thus delimited by the inner contour 4 is still present within the workpiece 3.

According to the invention, the workpiece 3 is picked up in a defined manner by a gripper 2 of a handling robot 1, that is, each workpiece 3 is picked up in an identical relative position to the gripper 2, with respect to the gripper 2 and a gripper coordinate system G (a, b, c) imagined on the gripper, and is held by the gripper 2. In this case, the gripper 2 is located in a reproducible predetermined pick-up position AP (x₁ y₁, z₁) with respect to a robot coordinate system R (x, y, z). Thus, the previously cut closed inner contour 4 of the workpiece 3 also has a defined relative position to the gripper 2. Via a control unit 5 of the handling robot 1, the gripper 2 itself can adopt any spatial position and orientation with respect to a robot coordinate system R (x, y, z) defined by the handling robot 1, within a limited radius of action. During the process, however, the gripper 2 is only moved into a predetermined first gripper position GP1 (x₂, y₂, z₂) and a predetermined second gripper position GP2 (x₃, y₃, z₃).

The first and second gripper positions GP1 (x₂, y₂, z₂), GP2 (x₃, y₃, z₃) are preferably determined by means of a sample workpiece before the start of the process. To determine the first gripper position GP1 (x₂, y₂, z₂), the workpiece 3 held by the gripper 2 is positioned in front of the inspection unit 7 in such a way that the latter is able to detect the nominal inner contour of the workpiece 3 and the relative position of said contour on the workpiece 3. The shape and relative position of the nominal inner contour are stored in relation to the gripper 2 and the current gripper position, which now represents the first gripper position GP (x₂, y₂, z₂). With respect to the gripper 2, the relative position of the nominal inner contour remains unchanged, while it changes with the movement of the gripper 2 with respect to the robot coordinate system R (x, y, z). Consequently, the spatial position of the inner contour 4 of the workpiece 3 in relation to the robot coordinate system R (x, y, z) is also known via the knowledge of the spatial position and the orientation of the gripper 2 in each case, if the relative position of the inner contour 4 in relation to the workpiece 3 is known.

Advantageously, the relative position of the inner contour 4 with respect to the workpiece 3 and thus to the gripper 2 can also be determined by means of the design documents in addition to the acquisition from a sample workpiece and stored as a nominal inner contour in a memory and computing unit 6. Advantageously, only individual control points on the inner contour KP1 (a₁, b₁, c₁), KP2 (a₂, b₂, c₂) were recorded and stored for this purpose, since it is basically not necessary to know the exact shape and position of the nominal inner contour. It was also stored which nominal values the inspection unit 7 records for selected control points within the inner contour KP3 (a₃, b₃, c₃) for a completely detached workpiece 3. It is mandatory that a nominal value has been recorded and stored for at least one control point within the inner contour KP3 (a₃, b₃, c₃).

In principle, it can be assumed that the inner contour 4 of the workpieces to be inspected (actual inner contour) matches the inner contour 4 of the sample workpiece (nominal inner contour) at least in its relative position with respect to the workpiece 3, or that the tolerance thereto is insignificant, especially since the inspection of only one control point within the inner contour KP3 (a₃, b₃, c₃) is basically sufficient. With this assumption, the gripper 2 can be positioned in the first gripper position GP1 (x₂, y₂, z₂), determined on the basis of the sample workpiece, to inspect the actual inner contour of the workpiece 3, and the at least one selected control point within the actual inner contour KP3 (a₃, b₃, c₃) can be inspected. Deviations of the actual inner contour in position and shape compared to the nominal inner contour result in the position of the selected control points deviating with respect to the inner contour.

To ensure that deviations in the shape and, in particular, the position of an actual inner contour relative to a nominal inner contour have no influence on the inspection result of a control point within the inner contour KP3 (a₃, b₃, c₃), an at least almost centrally located control point is advantageously inspected and the inspection result assigned to the control point, which represents an actual value, is compared with the stored nominal value.

The process begins by picking up the workpiece 3, with the gripper 2 in a predetermined pick-up position AP (x₁, y₁, z₁), as already explained. Then the gripper 2 is moved to a predetermined first gripper position GP1 (x₂, y₂, z₂) to an optical inspection unit 7. The spatial position of the inspection unit 7 in relation to the robot coordinate system R (x, y, z) is known, so that individual inspection results can be assigned to a respective control point with its coordinates in relation to the gripper coordinate system G (a, b, c) and also in relation to the robot coordinate system R (x, y, z). The workpiece 3 is inspected at the at least one control point within the inner contour KP3 (a₃, b₃, c₃). This means that the workpiece 3 is either optically inspected only at the at least one control point within the inner contour KP3 (a₃, b₃, c₃), which is possible, for example, with a laser scanner as the inspection unit 7, which emits a measuring radiation directed only at this at least one control point, or only the value for the at least one control point is stored and evaluated from a digital recording, e.g., of a camera as the inspection unit 7.

The inspection result obtained in each case is assigned to the coordinates of the respective control point and stored as an actual value in a memory and computing unit 6.

The actual value is compared with the stored nominal value and, if the deviation of the actual value from the nominal value exceeds a tolerance limit, the gripper 2 is actuated by the control unit 5, moved to the second gripper position GP2 (x₃, y₃, z₃), and fed to an ejector unit 8 with a ram 8.1 in such a way that the ram axis 8.0 of the ram 8.1 is directed into the area center MP of the inner contour 4 and the ram 8.1 is moved in the direction of the ram axis 8.0, which extends through the area center MP. The ram 8.1 is moved through the inner contour 4 and any slug still located in the inner contour 4 is pushed out.

Advantageously, a camera that generates a two-dimensional image of the workpiece 3 is used as the inspection unit 7, with the actual value assigned to the at least one control point within the inner contour KP3 (a₃, b₃, c₃) being the value of a light intensity of the image of said control point within the inner contour KP3 (a₃, b₃, c₃).

Alternatively, a laser scanner is advantageously used as the inspection unit 7, which scans the workpiece 3 at least one-dimensionally, with the actual value assigned to the at least one control point within the inner contour KP3 (a₃, b₃, c₃) being the value of a distance of the workpiece 3, or of a surface located behind it, from the inspection unit 7.

Advantageously, the inner contour 4 of the workpiece 3, which represents an actual inner contour, is also additionally inspected by the inspection unit 7 and the inspection result is compared with the inspection result of a previously inspected nominal inner contour of a sample workpiece. When a positional deviation of the actual inner contour from the nominal inner contour is detected, the predetermined second gripper position GP2 (x₃, y₃, z₃) is advantageously corrected. Thus, the ram axis 8.0 is not guided through the area center MP of the nominal inner contour but through the area center MP of the actual inner contour. This has the advantage that the outer contour of the ram 8.1, which is adapted to the inner contour 4, can be dimensioned with a smaller clearance to the inner contour 4, which allows a larger area contact with a slug that may still be present.

In other words, a positional deviation of the actual inner contour from the nominal inner contour is a deviation of an actual position of the inner contour from a nominal position with respect to the gripper 2. This can have various causes. On the one hand, the inner contour can be in an actual position deviating from a nominal position with respect to the outer contour of the workpiece 3. On the other hand, such a positional deviation can occur if the workpiece 3, when picked up by the gripper 2, assumes an actual position that deviates from a nominal position with respect to the gripper coordinate system G (a, b, c). By inspecting the position of the actual inner contour, i.e. its real relative position to the gripper coordinate system G (a, b, c), and correcting the second gripper position GP2 (x₃, y₃, z₃) in the case of an out-of-tolerance deviation from a nominal inner contour, i.e. the intended relative position to the gripper coordinate system G (a, b, c), it is possible to compensate for manufacturing tolerances when cutting the inner contour while also compensating for tolerances when picking up the workpiece 3.

Advantageously, following any post-processing that may have been performed, the gripper 2 is guided from the second gripper position GP2 (x₃, y₃, z₃) back to the first gripper position GP1 (x₂, y₂, z₂) and the workpiece 3 is inspected again.

### LIST OF REFERENCE NUMERALS

1 handling robot
2 gripper
3 workpiece
4 inner contour
5 control unit
6 memory and computing unit
7 inspection unit
8 ejection unit
8.0 ram axis
8.1 ram
R (x, y, z) robot coordinate system
G (a, b, c) gripper coordinate system
KP1 (a₁, b₁, c₁), KP2 (a₂, b₂, c₂) control points on the inner contour
KP3 (a₃, b₃, c₃) control point within the inner contour
AP (x₁, y₁, z₁) pick-up position
GP1 (x₂, y₂, z₂) first gripper position
GP2 (x₃, y₃, z₃) second gripper position
MP area center

1. A method for inspecting and post-processing a workpiece with a laser-cut closed inner contour, said method comprising:
optically checking whether a slug formed by cutting of the inner contour is still located within the workpiece,
inspecting the workpiece in at least one control point within the inner contour
associating an inspection result with the at least one control point representing an actual value which is compared with a nominal value,
picking up the workpiece with a gripper of a handling robot, wherein the inner contour of the workpiece assumes a defined relative position with respect to a gripper coordinate system defined on the gripper, and the gripper is located with the coordinate origin of the gripper coordinate system in a predetermined pick-up position, in a robot coordinate system defined by the handling robot,
moving the gripper is moved to a first predetermined gripper position to an optical inspection unit having a known spatial position relative to the robot coordinate system,
inspecting the workpiece at the at least one control point within the inner contour, and
when a deviation of the actual value from a desired value exceeds a tolerance limit, moving the gripper into a predetermined second gripper position of an ejection unit with a ram in such a way that a ram axis of the ram is directed through the area center point of the inner contour and the ram is moved in a direction of the ram axis, the ram being moved through the inner contour and pushing out any slug still located in the inner contour, whereby the post-processing takes place.

2. The method according to claim 1, wherein:
a camera that generates a two-dimensional image of the workpiece is used as the inspection unit, with the actual value assigned to the at least one control point within the inner contour being a value of a light intensity of an image of said control point.

3. The method according to claim 1, wherein:
a laser scanner is used as the inspection unit, which scans the workpiece at least one-dimensionally, with the actual value assigned to the at least one control point within the inner contour being a value of a distance of the workpiece, or of a surface located behind the workpiece, from the inspection unit.

4. The method according to claim 1, wherein:
the known first and the predetermined first and second gripper positions were determined and stored using a sample workpiece with a nominal inner contour.

5. The method according to claim 1, wherein:
the inner contour, which represents an actual inner contour, is additionally inspected by the inspection unit and an inspection result is compared with the inspection result of a previously inspected nominal inner contour of a sample workpiece.

6. The method according to claim 5, wherein:
in the case of a positional deviation of the actual inner contour from the nominal inner contour, the second gripper position is corrected. (Currently Amended) The method according to claim 1, wherein:
following any post-processing that may have been performed, the gripper is guided from the second gripper position back to the first gripper position and the workpiece is inspected again.
